(19) United States
(12) Patent Application Publication
(10) Pub. No.: US 2014/0097951 A1
(43) Pub. Date: Apr. 10, 2014

(54) BRAKE INDICATOR

(71) Applicant: Ivan GRGIC, Monmouth Junction, NJ (US)

(72) Inventor: Ivan GRGIC, Monmouth Junction, NJ (US)

(21) Appl. No.: 13/646,043

(22) Filed: Oct. 5, 2012

(51) Int. Cl. B60T 17/22; B60Q 1/00; B60Q 3/04; F16D 66/00; B60K 37/00

(52) U.S. Cl. 340/453; 188/1.11 R

(57) ABSTRACT

The brake indicator is a cylindrical device, measuring approximately one quarter of an inch in length and three-eighths of an inch in width. This component is a high temperature insulator pressed part with a round rod, as well as a wire configuration with terminal rubber booth protection. The wiring serves as the communication conduit between the brakes and the dashboard panel control inside the vehicle. The brake indicator assembly's sensor rod is positioned flush with each brake pad. Thus, the sensor rod will have contact with the rotor every time the brakes are depressed. As such, the indicator sensor rod will touch the rotor behind the brake pad before the pad wears down enough for a metal-on-metal contact. When the sensor rod touches the rotor, the wiring activates the warning light on the vehicle's dashboard, thereby informing the driver of the potential problem.

### BACKGROUND OF THE INVENTION

1. Field of the Invention

This invention relates generally to a brake indicator and, more particularly, the invention relates to a brake indicator providing a brake indicator system that monitors all wheels of a vehicle, as opposed to just one wheel.

2. Description of the Prior Art

As brake pads wear down, they reach a point where it is only a matter of time before metal-to-metal contact is reached. To prevent this, an indicator light on the vehicle's dashboard offers a visual warning. However, most vehicles have only one brake indicator, which can be a problem if the other brakes are failing. Unaware of the problem, motorists face a serious safety issue, not to mention a potentially large repair bill when the car is taken and subjected to service.

### BRIEF DESCRIPTION OF THE DRAWINGS

FIG. 1 is a schematic view illustrating a brake system of a first embodiment of the invention,

FIG. 2 is a schematic view of brake system according to a second embodiment,

FIG. 3 is a schematic view of a brake pad with a brake pad sensor,

FIG. 4 is a schematic view of a disk brake with brake pad sensors,

FIG. 5 is a perspective view illustrating a drum brake with a brake sensor,

FIG. 6 is a view of a motor vehicle dashboard with indicator lights,

FIG. 7 is a perspective view of a brake fluid reservoir.

### DETAILED DESCRIPTION OF THE PREFERRED EMBODIMENTS

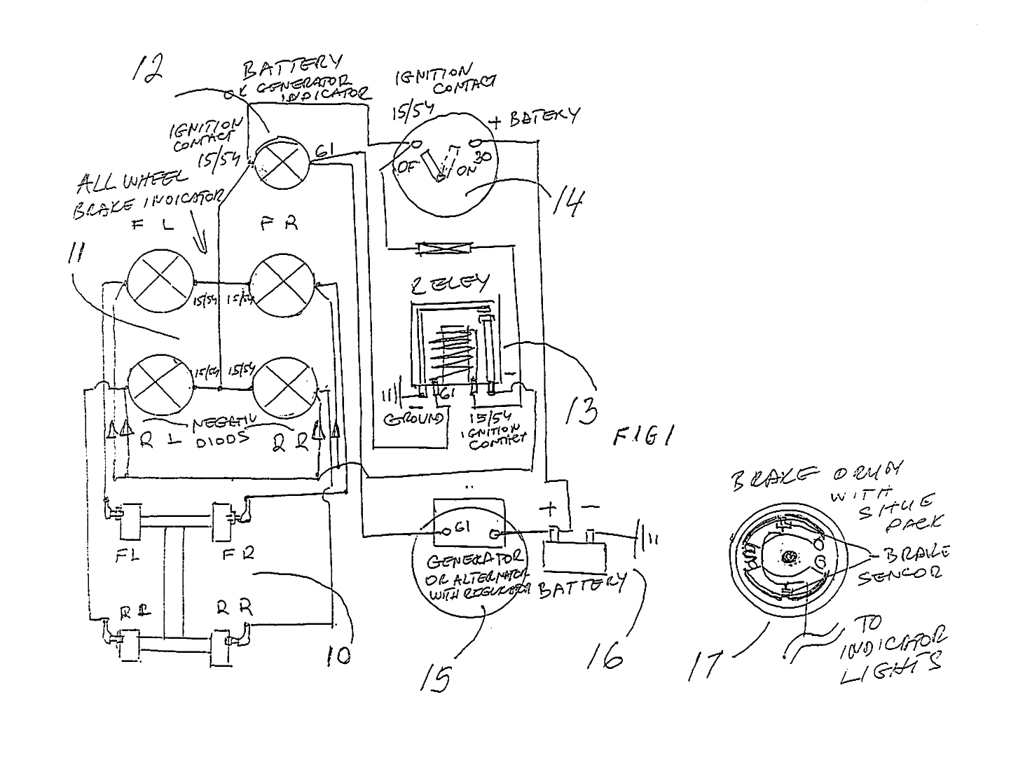

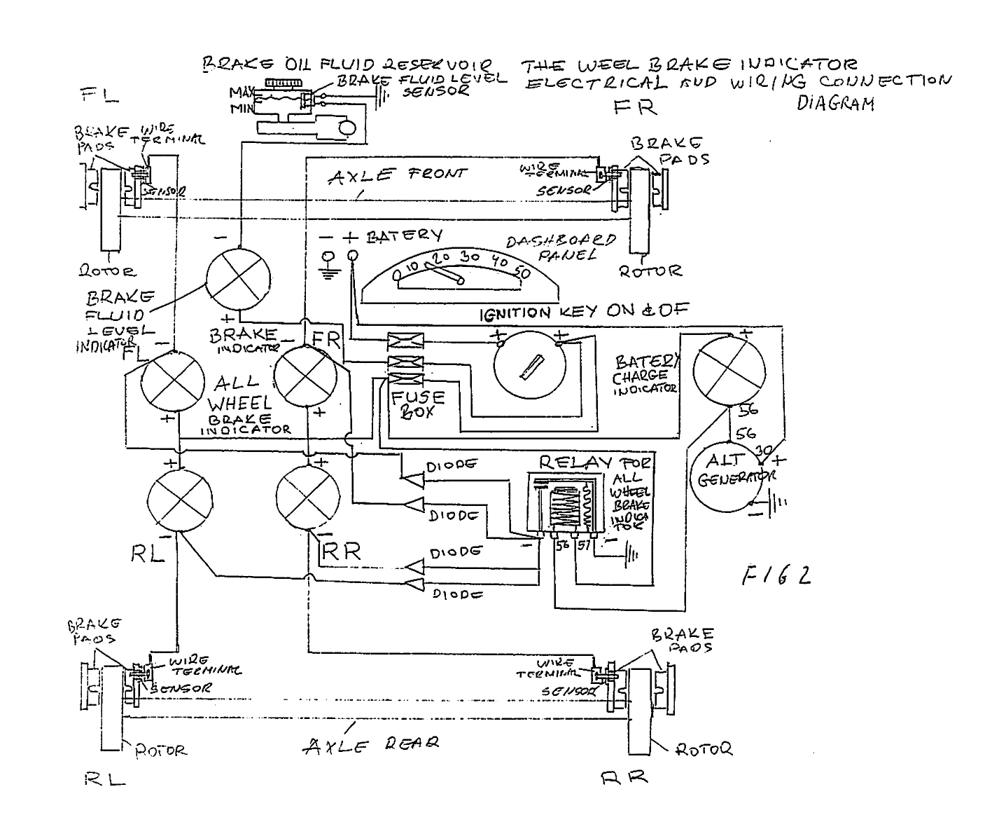

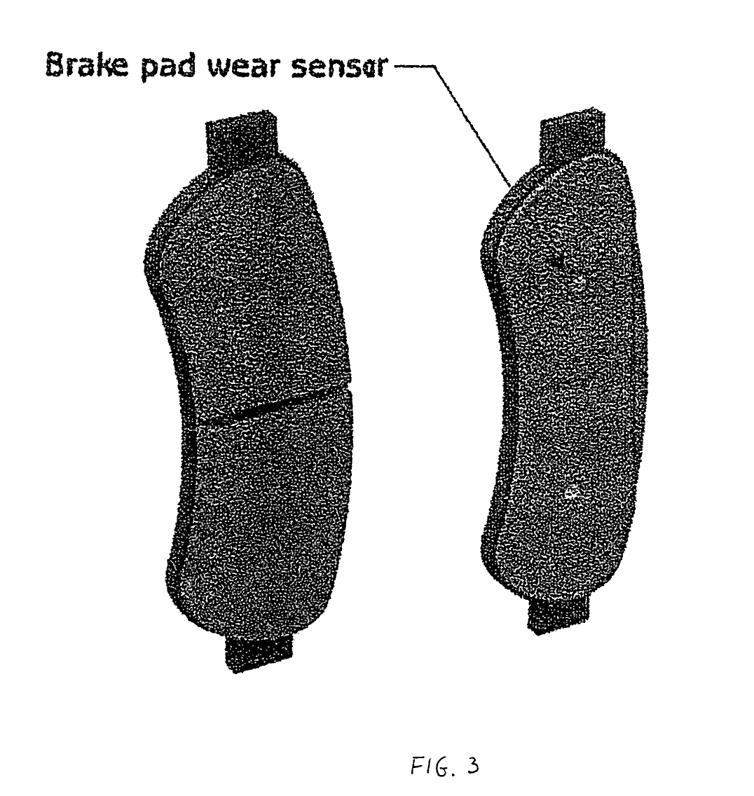

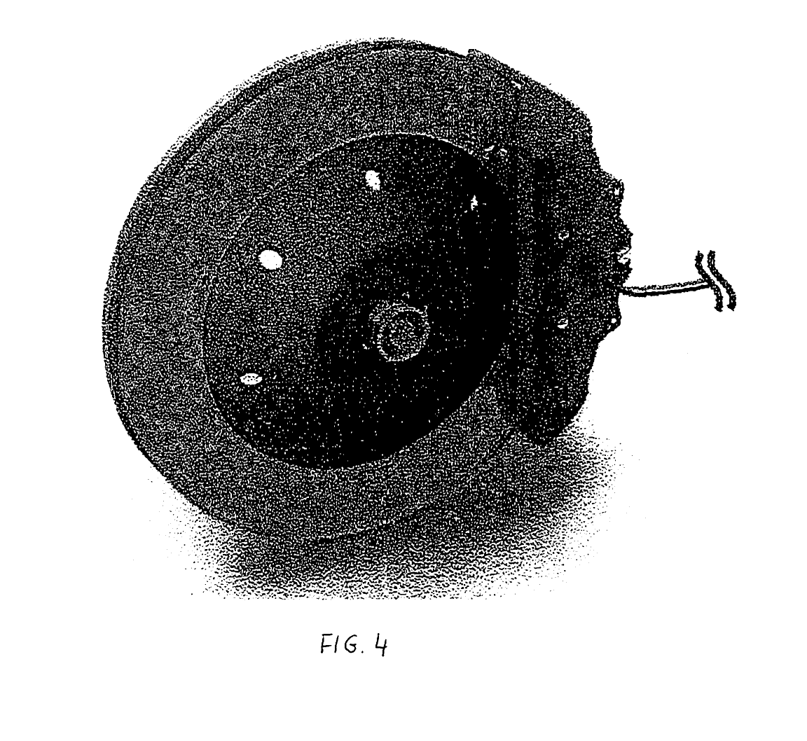

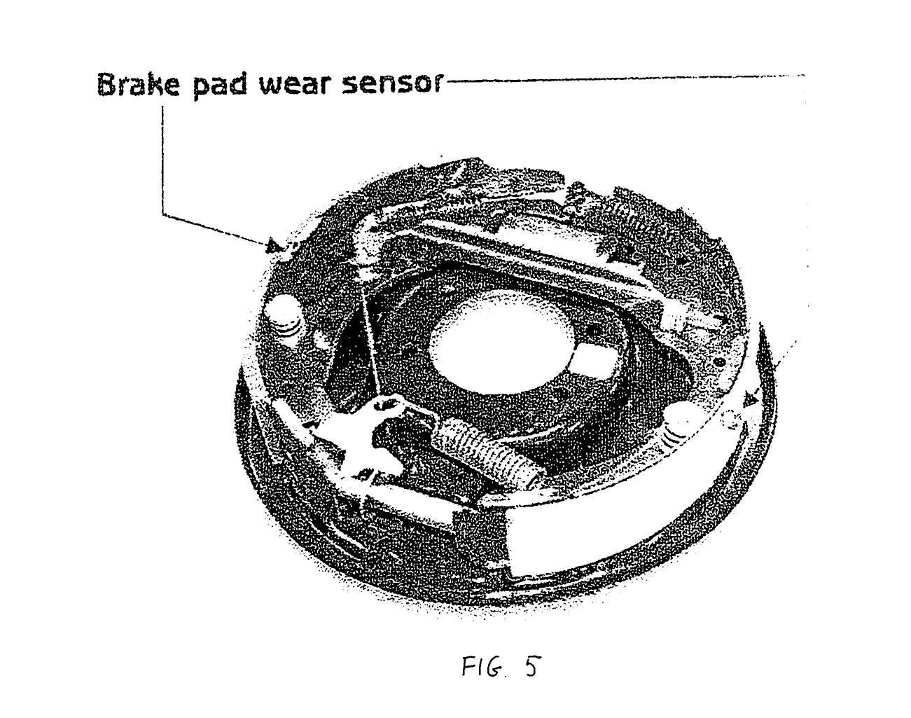

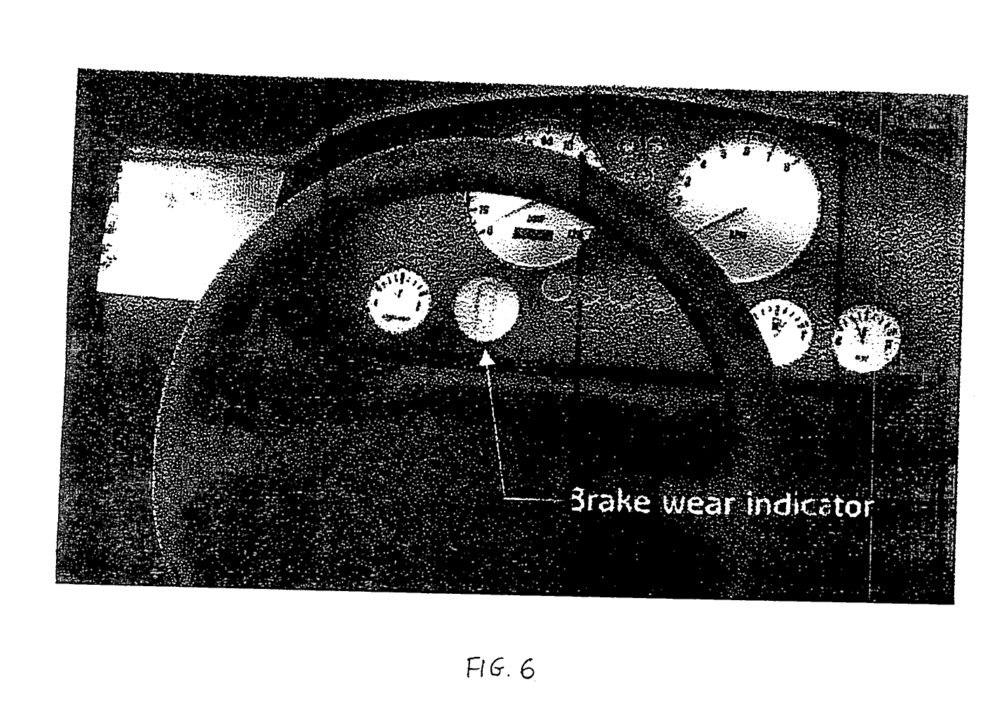

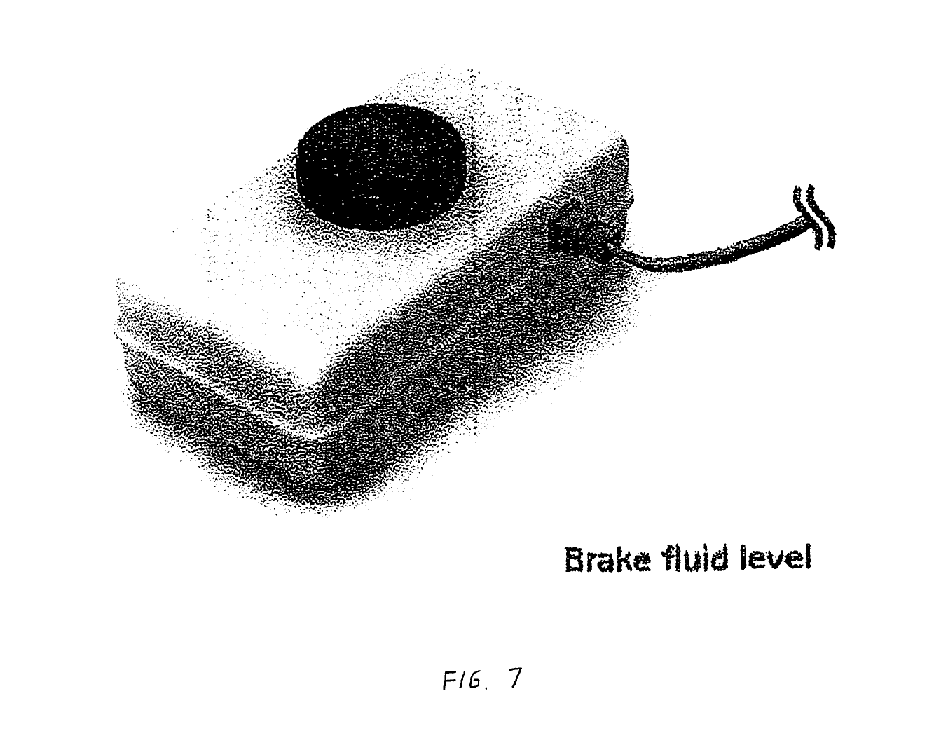

As illustrated in FIGS. 1 to 7, the present invention is a brake indicator providing a brake indicator system that monitors all wheels of a vehicle, as opposed to just one wheel. The brake indicator of the present invention allows motorists to keep track of wear and tear on each of their brakes, realizing possible brake problems before it is too late. the

The brake indicator system part is configured to be installed within each brake pad assembly. The brake indicator is a cylindrical device, measuring approximately one quarter of an inch in length and three-eighths of an inch in width. This component is a high temperature insulator pressed part with a round rod, as well as a wire configuration with terminal rubber booth protection. The wiring serves as the communication conduit between the brakes and the dashboard panel control inside the vehicle. The brake indicator assembly's sensor rod is positioned flush with each brake pad. Thus, the sensor rod will have contact with the rotor every time the brakes are depressed. As such, the indicator sensor rod will touch the rotor behind the brake pad before the pad wears down enough for a metal-on-metal contact. When the sensor rod touches the rotor, the wiring activates the warning light on the vehicle's dashboard, thereby informing the driver of the potential problem. The warning light system is configured with a grid-like map to show where the problem is actually occurring; a circled “X” is designated for brakes positioned at FL (front left), FR (front right), RL (rear left), and RR (rear right).

There are shown on FIG. 1 brake shoes 10 with brake shoe pads. The shoe pads are built in sensor pads made out of a high temperature resistant insulator to connect an electrical wire with a female terminal and male terminal to sense loads with insulator to brake shoe pads or wire can be pressed into indicator as to each wheel marked at FL (front left), FR (front right), RL (rear left), and RR (rear right).

The all wheel brake indicator has to be built and/or installed to the instrument panel of the dashboard 11 in a vehicle. Each indicator has to be connected with wire from the brake pad sensors. One side and another side is connected to the ignition key or battery light indicator like hot or + polarity marking 15/54 for each brake indicator light. A negative diode is connected to cold or − polarity from relay to prevent an open circuit. When the generator is on, power is given from engine running on. In case of any brake shoe wear out, the sensor will touch the rotor and give negative (−) on ground polarity to the indicator lights with other side + polarity or 15/54 will light up the indicator light bulb to warn the driver of a problem with the brake pads. It is a minimum that the shoe is yearly inspected for low points to brake the disk.

The battery or generator indicator 12 connects with the ignition key marking 15/54 one side and another to regulator or generator side with marking number 61 when Engine is off, 61 from generator is negative (−) or could polarity. When ignition key is on, battery light indicator will be on, when engine starts to run, that 61 becomes + or hot polarity, out bulb lights up on the indicator which means the battery generator is charging.

The relay 13 for Al Wheel Brake Indicator is connected to one side with all bulb lights, negative polarity or could connect through the negative diode the other side to ground when the relay kicks on from connection 15/54 ignition or (+) with the other side battery indicator or 61 negative (−) when key is on, all indicator lights bulb will turn on. When engine starts running, all light bulbs will be off because 61 becomes (+) or hot and 15/54 is (+) or hot polarity will shut down relay to shut all indicator lights. When any brake pads wear out, with pressing the brake pedal light indicator will go on.

The ignition key or contact 14 supply power to generator light bulb indicator and relay as well to All Brake Indicator. The light bulb from battery (+) or hot terminal for turning key on to ignition contact or turn engine running.

The generator or alternator 15 connect to the battery (+) polarity and from regulator to battery indicator bulb 61 will be negative or could one side of indicator battery bulb with other (+) or 15/54 light will go on when key is on start. Engine running generator provide electricity to regulator for charging battery. In that time 61 became (+) or hot polarity. Shut off light bulb indicator for battery. Will connect relay to All Wheel Brake Indicator.

The battery 16 will supply the main power to the vehicle.

A built in sensor 17 can be contained in the brake shoe as well as brake pads. The operation and connection is the same as the All Wheel Brake Indicator safety system.

There are several significant benefits and advantages associated with the brake indicator of the present invention. Foremost, the brake indicator provides motorists with an all-encompassing monitoring system for each of the vehicle's brakes. Unlike standard systems, which only indicate problems with one brake, the present brake indicator covers both front and rear brake assemblies, ensuring an optimal protection. As such, the brake indicator informs motorists, with every time the brakes are depressed, via their dashboards, of brake wear and tear long before it is too late to stop a disintegration of the brakes. This provides drivers with ample time to attend to the brakes before hearing the awful grinding sound which only signals a problem with the brake when the pads have completely worn down.

With such an easily visible warning system, users can avoid the high labor and material costs that invariably result from having to completely replace more than one set of brake pads. Most importantly, the brake indicator could help increase highway safety. Knowing ahead of time that one or more of their brakes are headed for trouble, the risk of brake failure while driving can be effectively alleviated and reduced. As a universal concept, the brake indicator accommodates virtually any automobile, independent of whether the automobile is classified as a compact sedan or full-sized pickup truck and can ensure protection for the brakes of any vehicle on the road.

The brake indicator of the present invention readily improves the performance of motor vehicles. Whether offered as an aftermarket product or installed on new vehicles at the point of manufacture, the brake indicator can help save money as well as well as avoid personal injuries.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the spirit and scope of the invention, and that the scope of the present invention is to be limited only by the claims except as precluded by the prior art. Moreover, the invention as disclosed herein may be suitably practiced in the absence of the specific elements which are disclosed herein.

The present invention furnishes a brake indicator comprising

a first brake pad;

a second brake pad;

a third brake pad;

a fourth brake pad;

a first brake sensor attached to the first brake pad;

a second brake sensor attached to the second brake pad;

a third brake sensor attached to the third brake pad;

a fourth brake sensor attached to the fourth brake pad;

a first connection wire attached to the first brake sensor;

a second connection wire connected to the second brake sensor;

a third connection wire attached to the third brake sensor;

a fourth connection wire attached to the fourth brake sensor;

a first indicator light connected to the first connection wire;

a second indicator light connected to the second connection wire;

a third indicator light connected to the third connection wire;

a fourth indicator light connected to the fourth connection wire;

an electrical power supply connected to the first connection wire, to the second connection wire, to the third connection wire, and to the fourth connection wire.

The brake indicator can further comprise a motor vehicle dashboard supporting the first indicator light, the second indicator light, the third indicator light and the fourth indicator light.

The brake indicator can be configured to be installed within each brake pad assembly at the point of manufacturing.
The All Wheel Brake Indicator will be a cylindrical device measuring approximately one quarter of an inch in length and three eights of an inch in width. This component will be a high temperature insulator sensor that will be pressed in with a tiny round rod with a negative connection on one side from the brake pad or shoe to the indicator light bulb on the dashboard and a positive connection on the other side from the fuse box to the other side of the light bulb on the dashboard for each All Wheel Brake Indicator. There will also be a wiring connection to the insulator sensor with a terminal rubber boot protection that will prevent against corrosion and provide a good electrical conduit.
The wiring will serve as the communication conduit between the brakes and the dashboard panel control inside the vehicle.
The assembly's insulator sensor with the tiny rod will be positioned slightly above the metal in the pads or the brake shoe. Every time the pad or shoe is worn out, when the brakes are depressed, the sensor rod will be able to touch the rotor or drum behind the brake pad or shoe before they are worn down enough to the point of metal-on-metal contact. When the insulator senior rod touches the rotor or drum and gives a negative contact with the rotor or drums, the wiring; will activate the warning light on the vehicle's dashboard, informing the driver of the potential problem.
The warning light system would be configured with a grid like map to show where the problem is actually occurring. a circled “X” would lie designated for brakes positioned at FL (front left), FR (front right), RL (rear left), and RR (rear right)

Advantages and benefits of the brake indicator are as follows:

As brake pads wear down, they reach a point where it is only a matter of time before metal-to-metal contact is reached.
Unlike standard systems, which only indicate problems with one brake, this invention would cover both front and rear brake assemblies, ensuring optimal protection The All Wheel Brake Indicator would inform motorists, via their dashboards, of brake wear and tear long before it is too late.
This warning system would provide drivers with ample time to attend to the brakes before hearing the awful grinding sound that only signals a problem when the pads have completely worn down With such an easily visible warning system, drivers could avoid the high labor costs that invariably result from having to completely replace more than one set of brake pads.
The All Wheel Brake Indicator would help increase highway safely Knowing ahead of time that one or more of their brakes are headed for trouble. The risk of brake failure while driving can be effectively alleviated.
The All Wheel Brake Indicator Electrical and Wiring Connection Diagram guides the installation.
From each wheel, the brake pad's sensor connection to the all wheel brake light indicator on the dash board will have a negative currency on one side when the brake pads wear out to touch the sensor, and on the other side of the indicator lights there will be a positive currency from the fuse box of the vehicle. When the key ignition is turned on, all positioned indicator lights will turn on, like the battery, oil level, brake, door, etc., and the all wheel brake indicator lights will also be activated from the negative relay currency connection to the circuit and the positive connection from the fuse box. The relay will disconnect from the circuit when the engine starts running because the alternator will become positive from its negative position, arid the all wheel brake lights will turn off until one of the brake pads wear out and touches the point sensor with the rotor will light up. Any pressing of the brake pedal will give a negative currency on the same side as the relay of indicator lights. For the brake fluid, the reservoir sensor's maximum and minimum fluid levels should be indicated like the brake fluid level lights. The all wheel brake indicator can be used and built on any motor vehicle type and design.

The brake indicator of the present invention readily improves the performance of motor vehicles. Whether offered as an aftermarket product or installed or on new vehicles at point of manufacture, the brake indicator can help save money or prevent personal injuries.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

1. A brake indicator comprising
a first brake pad;
a second brake pad;
a third brake pad;
a fourth brake pad;
a first brake sensor attached to the first brake pad;
a second brake sensor attached to the second brake pad;
a third brake sensor attached to the third brake pad;
a fourth brake sensor attached to the fourth brake pad;
a first connection wire attached to the first brake sensor;
a second connection wire connected to the second brake sensor;
a third connection wire attached to the third brake sensor;
a fourth connection wire attached to the fourth brake sensor;
a first indicator light connected to the first connection wire;
a second indicator light connected to the second connection wire;
a third indicator light connected to the third connection wire;
a fourth indicator light connected to the fourth connection wire;
an electrical power supply connected to the first connection wire, to the second connection wire, to the third connection wire, and to the fourth connection wire.

2. The brake indicator according to claim 1 further comprising a motor vehicle dashboard supporting the first indicator light, the second indicator light, the third indicator light and the fourth indicator light.
